(19) United States
(12) Patent Application Publication
(10) Pub. No.: US 2012/0152280 A1
(43) Pub. Date: Jun. 21, 2012

(54) Touch Sensitive Display For Surface Cleaner

(75) Inventors: Mark D. BOSSES, Boca Raton, FL (US); Charles BAIN, El Paso, TX (US); David WILLIAMS, El Paso, TX (US)

(73) Assignee: ZENITH TECHNOLOGIES, LLC, Boca Raton, FL (US)

(21) Appl. No.: 13/329,046

(22) Filed: Dec. 16, 2011

Related U.S. Application Data
(60) Provisional application No. 61/424,631, filed on Dec. 18, 2010.

(51) Int. Cl. A47L 9/28; B08B 7/04; G06Q 30/02; B08B 5/04

(52) U.S. Cl. 134/6; 15/339; 15/319; 134/18; 705/14.49

(57) ABSTRACT

A touch sensitive display displays status of operation and controlling operation of a surface cleaner. The touch sensitive display is connected to the surface cleaner and interfaces with a logic processor disposed in the surface cleaner. The logic processor receives information from the touch sensitive display, various sensors on and within the vacuum cleaner, and variable inputs. The logic processor outputs information to the touch sensitive display, and controls various functions and components of the surface cleaner. The information displayed on the touch sensitive display may be determined at least in part by the architecture of the logic processor and the touch sensitive display. The information displayed on the touch sensitive display can be varied among different surface cleaner systems and can depend upon the operational state of an individual surface cleaner. The logic processor can transmit information wirelessly over the internet to a remote station accessible by the user.

This application claims the benefit under 35 U.S.C. §119(e) of U.S. Provisional Application Ser. No. 61/424,631, filed Dec. 18, 2010, which is hereby incorporated by reference in its entirety.

### FIELD OF THE INVENTION

The present invention relates generally to a touch sensitive display interface for a surface cleaner. More particularly, the present invention relates to a surface cleaner having a touch sensitive display interface for inputting and displaying information to facilitate operation of the surface cleaner.

### BACKGROUND OF THE INVENTION

Surface cleaners, such as vacuum cleaners and carpet extractors, are generally well known in the art. However, a surface cleaner having a digital interface is not known in the prior art.

A typical surface cleaner has limited and rudimentary controls. For example, a user must stop operating a vacuum cleaner having a vacuum bag to determine whether the vacuum bag is full. The user must also physically check the belt of the vacuum cleaner to determine whether the belt is operational or broken. Accordingly, a need exists for improved control of a surface cleaner.

### SUMMARY OF THE INVENTION

The present invention provides an information display and input device, such as a human interface touch screen (“HI-TS”), on a “surface cleaner”, such as a vacuum cleaner or carpet extractor. Although the term HI-TS is used throughout this application, equivalents of the HI-TS are also contemplated for the present invention. Also, even though the term vacuum cleaner is used throughout this application, a carpet extractor, a combination vacuum cleaner and carpet extractor and equivalent technologies are also contemplated for the present invention. The HI-TS is connected to the surface cleaner and interfaces with a logic processor disposed in the surface cleaner. The logic processor, or microprocessor, in turn, receives information from the HI-TS, various sensors on and within the surface cleaner, and variable inputs. The logic processor outputs information to the HI-TS, and controls various functions and components of the surface cleaner. The information displayed on the HI-TS may be determined at least in part by the architecture of the logic processor and the display itself. The information displayed can also be varied among different surface cleaner systems and may depend upon the operational state of an individual surface cleaner. Accordingly, the HI-TS can be used to display and control multiple functions of the surface cleaner, including brush roll height, bag full indicator, and the like.

As used in this application, the terms “front,” “rear,” “upper,” “lower,” “upwardly,” “downwardly,” and other orientational descriptors are intended to facilitate the description of the exemplary embodiments of the present invention, and are not intended to limit the structure thereof to any particular position or orientation.

Other objects, advantages, and salient features of the present invention will become apparent from the following detailed description, which, taken in conjunction with the annexed drawings, discloses a preferred embodiment of the invention.

### BRIEF DESCRIPTION OF THE DRAWINGS

The various benefits, advantages and salient features of the present invention will become more apparent from the following detailed description of exemplary embodiments thereof and from the accompanying drawing figures, in which:

FIG. 1 is an illustration of an exemplary embodiment of a touch sensitive display for a vacuum cleaner;

FIG. 2 is a schematic diagram of the touch sensitive display of FIG. 1;

FIG. 3 is a top plan view of the touch sensitive display during operation of the vacuum cleaner of FIG. 1;

FIG. 4 is a schematic diagram of the touch sensitive display system in accordance with an exemplary embodiment of the present invention;

FIG. 5 is a schematic diagram of the touch sensitive display system of FIG. 1 in communication with a plurality of sensors;

FIG. 5A is an enlarged view of the touch sensitive display of FIG. 5 displaying a bag fullness level;

FIG. 6 is a schematic diagram of the touch sensitive display system of FIG. 1 in communication with a plurality of switching device;

FIG. 6A is an enlarged view of the touch sensitive display system of FIG. 6 displaying various controllable features of the vacuum cleaner;

FIG. 7 is a perspective view of the touch sensitive display system of FIG. 1 disposed on a handle of a vacuum cleaner; and

FIGS. 8-13 are top plan views of the touch sensitive display of FIG. 7 during operation of the vacuum cleaner.

Throughout the drawings, like reference numerals will be understood to refer to like parts, components and structures.

### DETAILED DESCRIPTION OF THE EXEMPLARY EMBODIMENTS

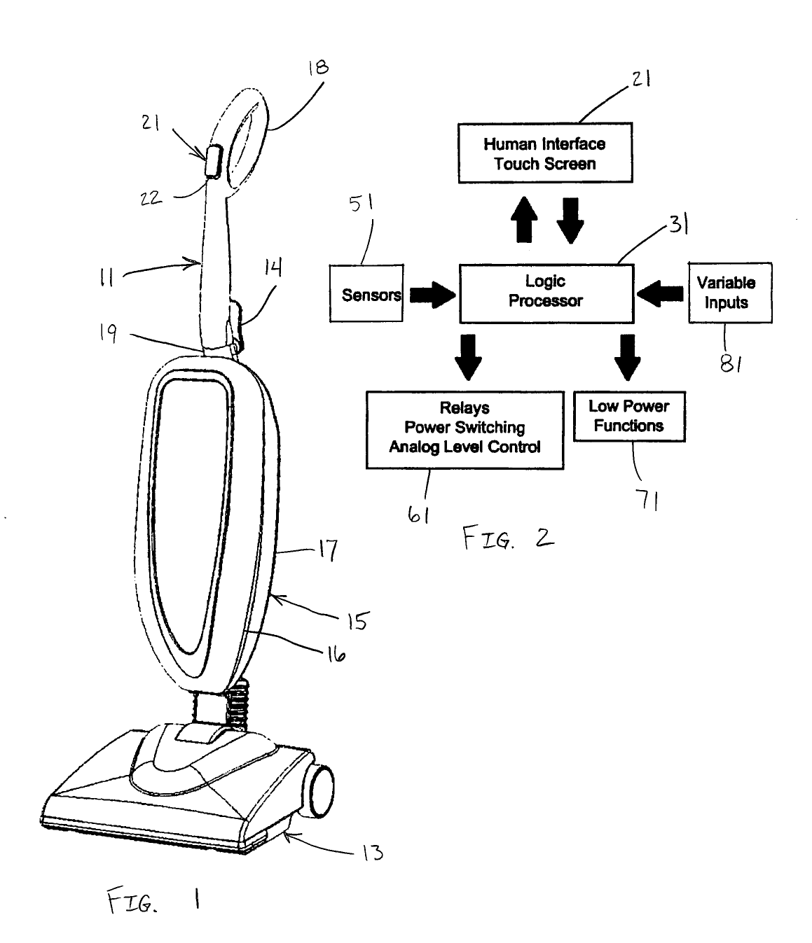

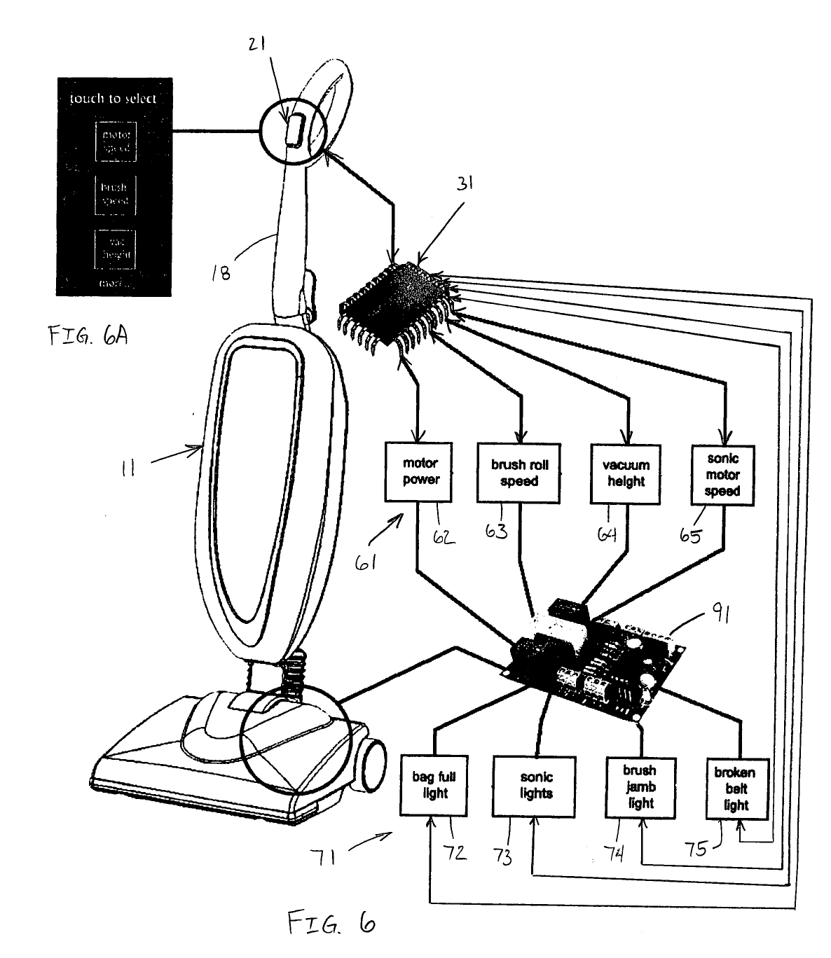

Exemplary embodiments of the present invention provide a display application, such as a touch screen display, on a surface cleaner that allows for the input and display of information. As shown in exemplary embodiments of the present invention in FIGS. 1-13, a human interface touch screen (“HI-TS”) 21 is affixed to a vacuum cleaner 11 and interfaces with a logic processor 31 to provide an interactive display. The HI-TS 21 is hereafter described with regard to an upright vacuum cleaner 11, although the HI-TS can be used with any suitable surface cleaner, such as a carpet extractor or a canister, backpack, stick, hand-held, central or built-in vacuum cleaner.

The HI-TS 21 is a pixel-based display screen or a fixed icon/word display screen having touch sensitive capabilities to display vacuum cleaner status information and to control functions of the vacuum cleaner through the use of touch areas of the HI-TS and a plurality of menu screens. The HI-TS 21 is a liquid crystal display (LCD), an organic light-emitting diode (OLED), or other suitable display technology. The touch sensitive capability of the HI-TS 21 may be performed through an indium tin oxide (ITO) capacitive sensor, capacitive proximity sensing, push buttons, switch contacts of various forms, or any other suitable touch screen technology.

During operation of the vacuum cleaner 11, the HI-TS 21 receives input from a user to control various functions and features of the vacuum cleaner while also displaying various information regarding the status of the vacuum cleaner and of the surface being cleaned. Accordingly, the vacuum cleaner 11 may be operated more efficiently and easily by the user, who is also afforded additional information regarding the status and operability of the vacuum cleaner.

The HI-TS 21 is attached to a handle 18 of the vacuum cleaner and interfaces with a logic processor 31, as shown in FIG. 1. The logic processor 31 can be of various suitable architectures. The logic processor 31 is mounted at any suitable location in the vacuum cleaner 11, such as in a base 13 thereof. Electrical wires connecting the logic processor 31 and the HI-TS 21 are preferably run in a conduit, or any other suitable shield, through an intake tube 19 to protect the wires from debris drawn in through a base 13 of the vacuum cleaner 11.

The vacuum cleaner 11 includes a housing 15 to receive a vacuum bag 41, as shown in FIGS. 1 and 4. The housing 15 is preferably porous to allow air passing through the vacuum bag 41 to pass through the housing. The housing 15 has a first housing part 16 and a second housing part 17. The first housing part 16 is secured to the vacuum cleaner 11, as shown in FIGS. 1 and 6. The second housing part 17 is movably connected to the first housing part 16, such as with a hinge. The remaining portion of the second housing part 17 is connected to the first housing part 16 in any suitable manner, such as with a zipper, to enclose the vacuum bag 41 therein. The second housing part 17 is openable with respect to the first housing part 16, to facilitate installing and removing the vacuum bag 41. The vacuum bag 41 is connected to the vacuum cleaner 11 in any suitable manner, such as with an attachment assembly 29 disclosed in copending U.S. patent application Ser. Nos. 13/074,846, filed Mar. 29, 2011, and 61/491,782, filed May 31, 2011, both to Mark D. Bosses and both of which are hereby incorporated by reference in their entirety.

The handle 18 is connected to the intake tube 19 of the vacuum cleaner 11, as shown in FIG. 1. A first end of the intake tube 19 is connected to an intake port in a base 13 of the vacuum cleaner 11, and a second end of the intake tube 19 is connected to the vacuum bag 41. An electrical cord (not shown) to supply electrical power to the vacuum cleaner 11 can be wrapped around an upper cord hook 14 and a lower cord hook (not shown) for convenient storage of the electrical cord when the vacuum cleaner 11 is not in use. The HI-TS 21 is disposed on the handle 18 such that the HI-TS is readable by a user during operation of the vacuum cleaner 11.

A motor 42 disposed in the base 13 of the vacuum cleaner 11 is operated by electrical power supplied through the electrical cord. The motor 42 drives a fan, which rotates to draw air into an intake port in the base 13 of the vacuum cleaner 11. The intake port is in fluid communication with the intake tube 19, thereby fluidly connecting the intake port to the vacuum bag 41. A belt 44 is connected to a brush roll 43 to rotate the brush roll to loosen debris on a surface to be cleaned, such as a carpet, and facilitate drawing debris into the vacuum cleaner with the air being drawn in by the fan. The belt 44 is connected to the motor 42. Alternatively, the belt 44 can be connected to a separate motor such that the brush roll 43 can be turned off while still running the vacuum cleaner 11, such as when cleaning a hard floor such that the brush roll does not disturb debris on the floor. A vibrating member can be used in combination with the brush roll 43 to further facilitate the cleaning effectiveness of the vacuum cleaner 11. A vibrating member is disclosed in U.S. Pat. No. 7,234,198 to Bosses, which is hereby incorporated by reference in its entirety. The vibrating member can also be driven by the motor 42, or can be connected to a separate motor.

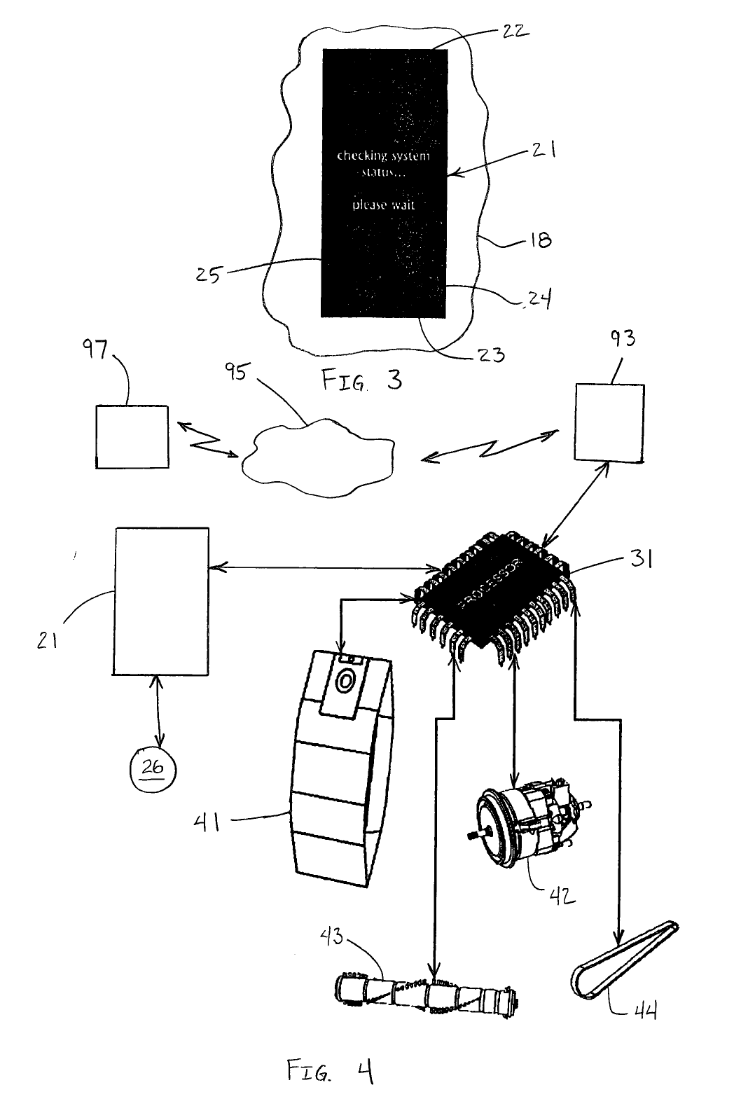

An exemplary HI-TS 21 is shown in FIG. 3. The HI-TS 21 is shown having a substantially rectangular shape, although any suitable shape may be used. The HI-TS 21 has an upper edge 22, a lower edge 23 and first and second side edges 24 and 25 to form a rectangular display as shown in FIG. 3. As shown in FIG. 1, the upper edge 22 of the HI-TS 21 faces downwardly such that the HI-TS 21 is readable, i.e., not upside-down, to a user operating the vacuum cleaner 11. A gyroscope 26, as shown in FIG. 4, can be connected to the HI-TS 21 such that the display is automatically oriented to be viewable by the user. Alternatively, a switch can control the orientation of the HI-TS 21 such that when the handle 18 is in the upright position, as shown in FIG. 1, the display of the HI-TS 21 is right-side up to the user standing in front of the handle 18 of the vacuum cleaner 11. When the handle 18 is rotated out of the upright position, such as during operation of the vacuum cleaner 11, the switch reorients the display of the HI-TS 21 to be readable to the user standing behind the handle 18 operating the vacuum cleaner 11.

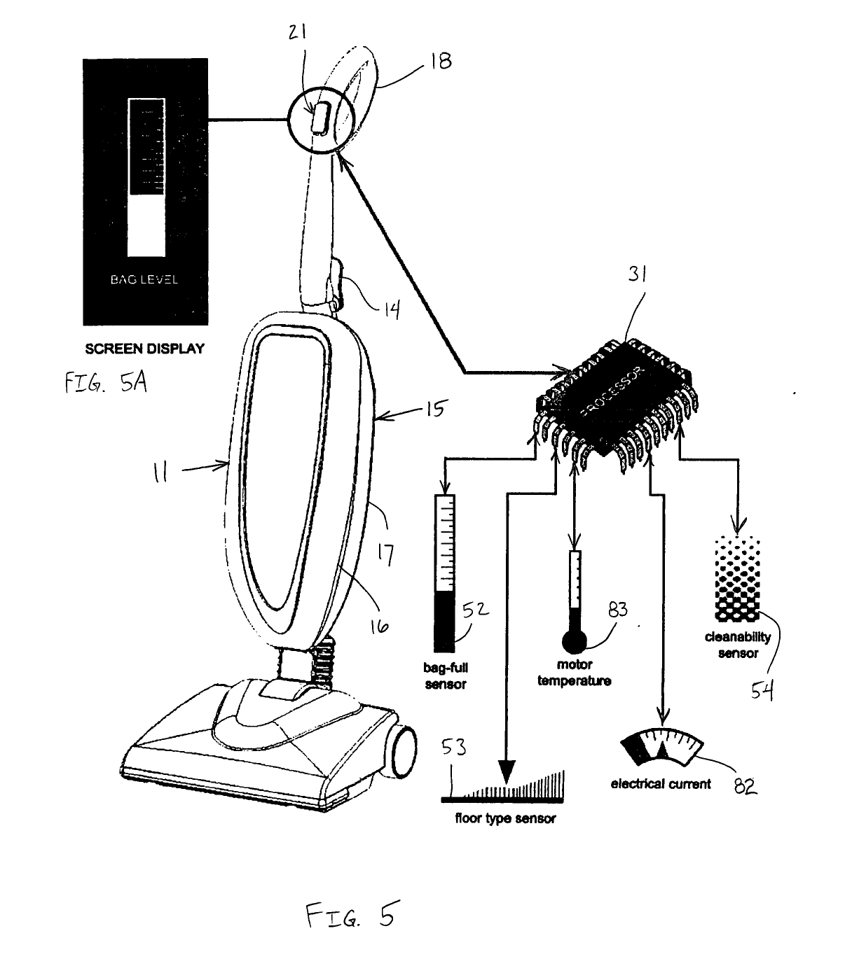

The logic processor 31 receives information input into the HI-TS 21 and from various sensors 51 and variable inputs 81 from various areas of the vacuum cleaner 11, as shown in FIGS. 2, 4 and 5. The logic processor 31, in turn, may output information to the HI-TS 21 and control the various functions and features of the particular vacuum cleaner 11 it is attached to, as shown in FIGS. 4 and 5. The logic processor 31 receives information from various sensors and conditional inputs from various areas of the vacuum cleaner 11. The logic processor 31 determines which menu screen is displayed on the HI-TS 21, and receives commands input by the user through the HI-TS. The HI-TS 21 screens and icons transition between each other based on the architecture of the logic processor 31. Accordingly, the logic processor 31 can control a plurality of vacuum functions, such as, but not limited to, turning the brush roll 43 on and off, turning headlights on and off, and adjusting the height of the brush roll 43 (such as by adjusting the height of the base 13 to which the brush roll 43 is connected). Operating aspects of the vacuum cleaner 11 are controlled by the logic processor 31, such as, but not limited to, turning the vacuum cleaner 11 on and off, displaying the life of the vacuum belt 44, displaying the life of the brush roll 43, and displaying the fullness of the vacuum bag 41. The logic processor 31 also accumulates and stores maintenance data for motor 42 run time, which can be monitored and displayed at the user's discretion.

Sensors 51 can be located in many areas of the vacuum cleaner 11 and send sensed information to the logic processor 31, as shown in FIGS. 2 and 5. The sensors 51 can indicate extremes of information, such as, but not limited to, a bag-full sensor 52, belt condition sensor, floor type sensor 53, and cleanability or the performance of the vacuum cleaner sensor 54. The sensors 51 can be, but are not limited to, pressure sensors, vacuum sensors, switches that are activated when certain actions are taken, amperage or current sensors 55, temperature sensors 56, machine configuration sensors and operational position sensors.

Variable inputs 81 can also be located in many areas of the vacuum cleaner 11 to send sensed information to the logic processor 31, as shown in FIGS. 2 and 6. The variable inputs 81 can vary between a range of values and are transmitted to the logic processor 31. The logic processor 31 uses the variable inputs 81 to make decisions and display information and control screens on the HI-TS 21 for further action by the user. Variable inputs 81 can include, but are not limited to, voltage of the motor, amperage of the motor 82, temperature of the motor 83, and distance traveled by the vacuum cleaner 11.

The logic processor 31 interfaces with the physical components of the vacuum cleaner 11 through relays and power switching devices 61 and 71 mounted on a circuit board 91 when the power required for the activity is above logic level powers. Switching devices 61 and 71 are used to control motors and other powered sections. The main vacuum power can enter the vacuum cleaner 11 and be switched to the various sections through a network of controlled switches 61 and 71, as determined by the logic processor 31. These outputs are not always simply on or off, but can be level controls for components, such as, but not limited to, motor power 62, light output, brush roll speed 63, vacuum height 64, and sonic motor speed 65. Low power functions 71 include, but are not limited to, sounds, lighting, and warning lights, such as a bag full light 72, sonic lights 73, brush jamb light 74 and broken belt light 75.

In an example of a particular embodiment of a touch sensitive display screen for a vacuum cleaner 11 in accordance with an exemplary embodiment of the present invention, a capacitive touch screen 21 may be mounted to the handle 18 of the upright vacuum cleaner 11. The touch screen 21 sends user input to the logic processor 31, which can control the various functions and features of the vacuum cleaner 11, including, but not limited to, turning the brush roll 43 on or off, turning the headlights on or off, adjusting the height of the vacuum cleaner, or the operation of the vibrating member. The logic processor 31 may also receive inputs from various sensors 51 and variable inputs 81 on the vacuum cleaner 11, as shown in FIGS. 2-4. The logic processor 31 can output information to a display, such as the HI-TS 21, selected by the user of the vacuum cleaner 11, which selection is made through the HI-TS as shown in FIG. 5. The logic processor 31 controls the vacuum cleaner 11 through a network of controlled switches. The switches can be for higher power switching 61 and lower power switching 71 functions, some of which are shown in FIG. 6.

A wireless adapter 93 can be connected to the logic processor 31 to communicate with the internet 95. The user can input an email address or mobile device number such that information can be sent over the internet 95 by the wireless adapter 93 to a remote station 97. Any suitable wireless transmission standard can be used, such as, but not limited to, radio, cell, LAN, Bluetooth and RF. For example, a message can be sent to the user's email account that the vacuum bag 41 is nearly full and a new bag needs to be purchased or that maintenance is due on a particular component. Such message can be in the form of an email to an account input into the HI-TS 21 by the user or a text message to a mobile device input into the HI-TS by the user. Additionally, information can be transmitted by the wireless adapter 93 over the internet 97 to an authorized service center or a manufacturer to facilitate maintenance or repair issues for the vacuum cleaner 11.

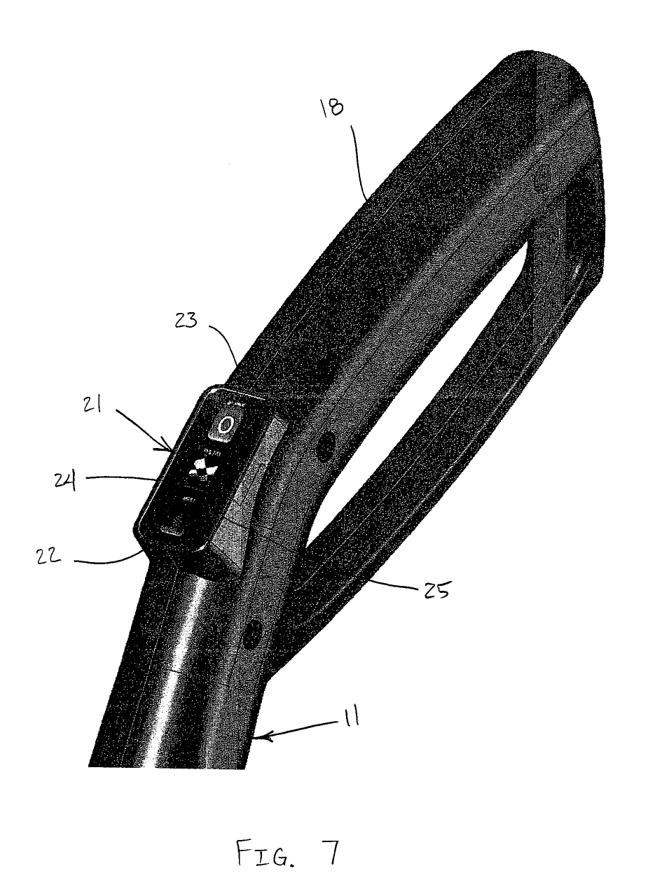

The power cord of the vacuum cleaner 11 is plugged into an electrical outlet to supply power to the vacuum cleaner. As power is supplied to the HI-TS 21, a start-up screen is displayed as shown in FIG. 8. The logic processor 31 then causes a checking system status screen to be displayed on the HI-TS 21, as shown in FIG. 9, as the logic processor 31 receives input from the sensors 51 and variable inputs 81 to ensure that all components are functioning properly. A logo 30 can be displayed on the HI-TS 21 during the start-up and system check screens, as shown in FIGS. 8 and 9. Rotating lights 32 can encircle the logo 30 during the system check screen, as shown in FIG. 9, to indicate to the user activity by the logic processor 31.

Once the logic processor 31 has determined all components are functioning properly, a ready screen having a plurality of icons 33 is displayed, as shown in FIG. 10. For example, the ready screen can display a carpet icon 34, a hard floor icon 35 and a power off icon 36.

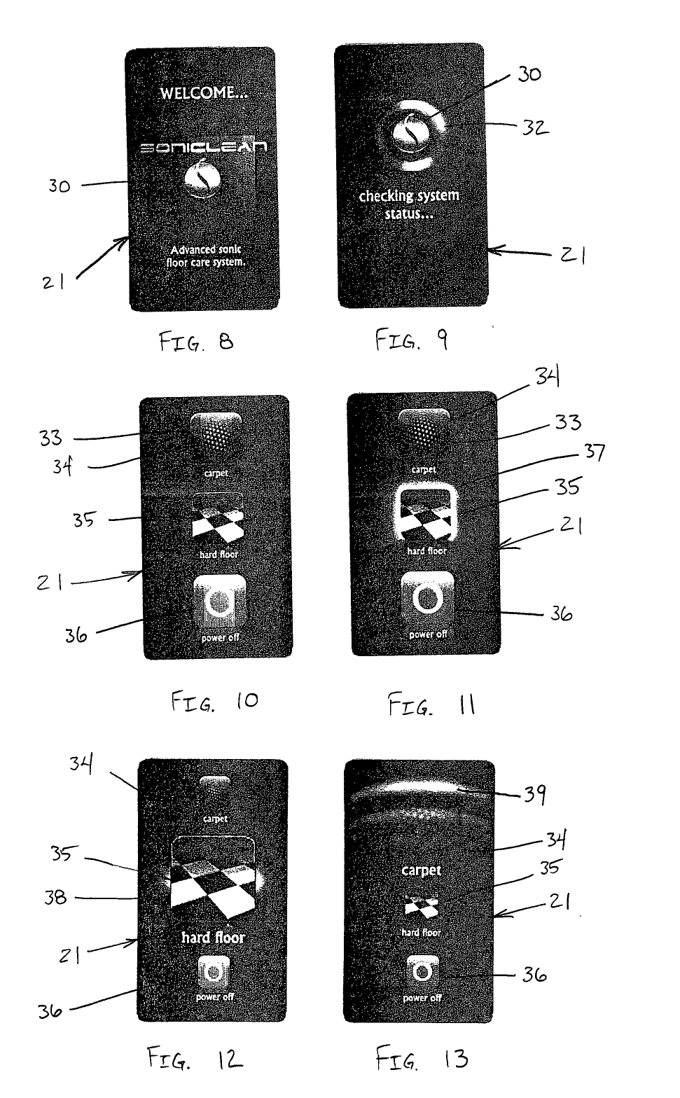

As shown in FIG. 11, the hard floor icon 35 is selected by the user by touching the icon on the HI-TS 21. A glowing light 37 surrounds the selected icon to facilitate visibility to the user to ensure the proper icon is selected. As shown in FIGS. 12 and 13, the selected icon is enlarged relative to the non-selected icons to indicate the selected mode by the user. In FIG. 12, the hard floor icon 35 is selected, and in FIG. 13 the carpet icon 34 is selected. Additionally, lights can be used in conjunction with the enlarged icon to indicate the selected mode. As shown in FIG. 12, a steady light 38 is displayed behind the hard floor icon 35. The steady light can be colored, such as a blue light, to facilitate visibility. As shown in FIG. 13, pulsing lights 39 can be displayed on top of the enlarged carpet icon 34. The pulsing lights 39 can be colored, such as blue, to facilitate visibility. The logic processor 31 transmits pre-programmed height information to the high power switch 64 controlling vacuum height to adjust the vacuum height in response to the selected icon 33. When the carpet icon 34 is selected, the logic processor 53 receives information from the floor type sensor 53 to further adjust the height of the vacuum cleaner depending on the sensed height of the carpet pile. An existing vacuum cleaner height adjustment device is disclosed in U.S. Pat. No. 5,056,175 to Stein et al., which is hereby incorporated by reference in its entirety.

The first time the vacuum cleaner 11 is used, the user can input an email address and/or a mobile device number to allow messages to be sent to such a remote station 97. Additionally, addresses corresponding to the authorized service center and/or the manufacturer can be pre-programmed into the logic processor 31 such that information can be transmitted thereto as necessary.

During operation of the vacuum cleaner 11, status information can be displayed on the HI-TS 21 regarding status information transmitted to the logic processor 31 from the sensors 51 and variable inputs 81. As an example, a status message is displayed on the HI-TS 21 when a roll brush jamb occurs. A sensor 51 is disposed proximal the brush roll 43. When the rotational speed of the brush roll 43 drops below a predetermined value, a signal is transmitted from the sensor 51 to the logic processor 31, which causes a status message to be displayed on the HI-TS 21 regarding the roll brush jamb. Additionally, a signal is sent to a lower power switching device 71 on the printed circuit board 91 to cause a roll brush jamb indicator light 74 disposed on the vacuum cleaner 11 to illuminate to indicate a roll brush jamb has occurred.

Another status message that can be sent during operation of the vacuum cleaner 11 is a change vacuum bag status message. As shown in FIG. 5A, a bar graph is displayed on the HI-TS 21 indicating the current fullness of the vacuum bag 41. When the vacuum bag 41 is full, a status message indicating that the vacuum bag needs to be replaced is caused to be displayed on the HI-TS 21 by the logic processor 31. A sensor 51 is disposed proximal the intake port in the vacuum cleaner 11 to measure the static pressure. As the vacuum bag 41 begins to fill, the static pressure will start to decrease. When the measured static pressure at the intake port falls below a predetermined value, the vacuum bag 41 is full and needs to be replaced. Accordingly, a message can be displayed on the HI-TS 21 and a bag full light 72 can be illuminated on the vacuum cleaner 11. The HI-TS 21 can also include an icon that can be actuated by the user to display ordering and contact information regarding the vacuum bag. Alternatively, the HI-TS 21 can display a scroll down message, such that the user can scroll down the HI-TS to obtain ordering and contact information regarding the vacuum bag. Additionally, a message can be sent through the internet to an inputted remote address for the user regarding the bag full status. This message can include ordering and contact information for purchasing vacuum bags.

Another controllable feature of the vacuum cleaner 11 is the cleanability sensor 54, as shown in FIG. 5. The cleanability sensor 54 senses the amount of debris entering the intake port of the vacuum cleaner 11 and adjusts the speed of the brush roll 43 accordingly. A conventional dust adjusting device is disclosed in U.S. Pat. No. 5,136,750 to Takashima et al., which is hereby incorporated by reference in its entirety.

The surface cleaner can be a robotic-type vacuum cleaner that is stored in a charging base. The robotic-type vacuum cleaner is battery-powered. The battery is recharged when the robotic-type vacuum cleaner is connected to the charging base. The logic processor is remotely accessible while being charged on the charging base, such that the user can remotely access the robotic-type vacuum cleaner to ascertain whether any components require maintenance or replacement. Additionally, the user can remotely access the logic processor to activate the robotic-type vacuum cleaner to follow one of a plurality of pre-programmed cleaning instructions.

Other status information is displayable on the HI-TS 21 and includes, but is not limited to, status of wearable parts (e.g., brush roll and belt), the hours of operation of the vacuum cleaner and components thereof, service intervals and service requirements. The status information can include a message indicating that maintenance is required for a component of the surface cleaner, such as, but not limited to, replacing or cleaning filters, replacing the brush roll, replacing the belt, and cleaning the dust bin and cyclones. Information regarding ordering information, such as websites and contact information, can be sent to the HI-TS 21 and/or to the remote station 97 regarding, but not limited to, vacuum bags 41, filters, and fragrance dispensers.

The foregoing embodiments and advantages are merely exemplary and are not to be construed as limiting the scope of the present invention. The description of exemplary embodiments of the present invention is intended to be illustrative, and not to limit the scope of the present invention. Various modifications, alternatives and variations will be apparent to those of ordinary skill in the art, and are intended to fall within the scope of the invention as defined in the appended claims and their equivalents.

What is claimed is:

1. A surface cleaner, comprising:
a body; and
a touch sensitive display disposed on said body for displaying and controlling operation of said surface cleaner; and
a logic processor electrically connected to said touch sensitive display to communicate therewith to cause said surface cleaner to operate in accordance with the communications.

2. The surface cleaner in accordance with claim 1, wherein
wherein said touch sensitive display is an LCD or OLED.

3. The surface cleaner in accordance with claim 2, wherein
a sensor disposed on said body is electrically connected to said logic processor to transmit and receive signals therefrom.

4. The surface cleaner in accordance with claim 3, wherein
said sensor is a temperature sensor.

5. The surface cleaner in accordance with claim 3, wherein
said sensor is a pressure sensor.

6. The surface cleaner in accordance with claim 3, wherein
a status message is displayed on said touch sensitive display indicating that a vacuum bag is full responsive to a condition sensed by said sensor.

7. The surface cleaner in accordance with claim 3, wherein
said logic processor sends a status message indicating an operating condition of said surface cleaner to a remote station over the internet.

8. The surface cleaner in accordance with claim 3, wherein
said sensor senses a rotational speed of a roll brush and adjusts a height of the roll brush in accordance with the sensed rotational speed.

9. The surface cleaner in accordance with claim 1, wherein
said touch sensitive display screen is an ITO, capacitive proximity sensing, push button or a switch contact.

10. The surface cleaner in accordance with claim 3, wherein
said logic processor sends a signal to a switch responsive to a condition sensed by said sensor, said switch adjusting an operating condition of the surface cleaner.

11. A method of operating a surface cleaner, comprising the steps of
touching a touch sensitive display to turn on a power supply to the surface cleaner; and
controlling settings of the surface cleaner through the touch sensitive display.

12. The method of operating a surface cleaner in accordance with claim 11, further comprising
displaying a menu on the touch sensitive display screen through which settings of the surface cleaner are controlled.

13. The method of operating a surface cleaner in accordance with claim 11, further comprising
sensing a rotational speed of a roll brush of the surface cleaner; and
stopping rotation of the roll brush when the roll brush rotational speed is below a predetermined value.

14. The method of operating a surface cleaner in accordance with claim 11, further comprising
sensing an operating condition of the surface cleaner; and
displaying an status message on the touch sensitive display screen responsive to the sensed operating condition.

15. The method of operating a surface cleaner in accordance with claim 14, wherein
the sensed condition is the operating condition of a belt of the surface cleaner.

16. The method of operating a surface cleaner in accordance with claim 14, wherein
the sensed condition is a static pressure of the surface cleaner.

17. The method of operating a surface cleaner in accordance with claim 16, wherein
a bag fullness indicator is displayed on the touch display screen responsive to the sensed static pressure.

18. The method of operating a surface cleaner in accordance with claim 14, wherein
the sensed condition is transmitted wirelessly to a remote station.

19. The method of operating a surface cleaner in accordance with claim 18, wherein
the wireless transmission to the remote station includes information for ordering a replacement part for the surface cleaner.

20. The method of operating a surface cleaner in accordance with claim 11, wherein
touching a power icon on the touch sensitive display screen turns off the power supply to the surface cleaner.

21. The method of operating a surface cleaner in accordance with claim 14, wherein
the status message indicates maintenance is required responsive to the sensed condition.
